(19) United States
(12) Patent Application Publication
(10) Pub. No.: US 2019/0152796 A1
(43) Pub. Date: May 23, 2019

(54) Preparation of Stable Copper(II) Hydroxide

(71) Applicant: NANO THERANOSTICS, INC, Elmsford, NY (US)

(72) Inventors: Vyom Parashar, Ossining, NY (US); Christian Michel, Ossining, NY (US)

(73) Assignee: Nanotheranostics Inc., Elmsford, NY (US)

(21) Appl. No.: 16/091,423

(22) PCT Filed: Apr. 19, 2017
(86) PCT No.: PCT/US17/28294

§ 371 Date: Oct. 4, 2018

Related U.S. Application Data
(60) Provisional application No. 62/325,424, filed on Apr. 20, 2016.

(51) Int. Cl. C01G 3/02

(52) U.S. Cl. CPC C01G 3/02; A01N 59/20

(57) ABSTRACT

A method for producing stable copper(II) hydroxide. The method comprises the treatment of a copper metal powder in an acidic aqueous solution containing acetic acid in the pH range less than 3.0 and at temperature below 30 ° C. under stirring conditions. To this acidic solution an alkali metal hydroxide solution is added to raise the pH above 7.0 to form copper(II) hydroxide. The method also comprises preparation of copper(II) hydroxide by treating the copper salts water solution with an alkali metal hydroxide solution in the pH range 7.0 to 12. To improve the stability of the copper(II) hydroxide prepared according to all the said method, a small amount of alkali or alkaline metal gluconate can be added to the suspension before or after the reaction. Also disclosed is a composition comprising stabilized copper(II) hydroxide prepared according to the method and at least one of a plant derived extract demonstrated to have antifungal, antibacterial or antiviral activity as a solid or a liquid or as a surfactant or as a coating.

### BACKGROUND OF THE INVENTION

The present invention relates to a method for producing color stable copper(II) hydroxide, also known as cupric hydroxide (Chemical formula: Cu(OH)₂). Copper(II) hydroxide has a broad range of commercially important applications including but not limited to fungicides and bactericides, marine paints, as a mordant and pigment in dyeing textile and paper fibers as well as in the preparation of catalysts and other copper compounds.

Blue color Copper(II) hydroxide is thermodynamically unstable and decomposes readily to brown-black copper(II) oxide. To overcome the innate instability, the formation of copper(II) hydroxide requires well controlled process conditions. Furthermore, avoiding the decomposition of copper(II) hydroxide during its storage and use is a major concerned in the manufacture, distribution and storage of copper(II) hydroxide and compositions containing it. The decomposition of the copper(II) hydroxide may be attributed to strong alkaline conditions and temperature as reported by H. Jaggi et al. Acta Cryst 14, 1041, 1961 and H. B. Weiser et al. J. Am. Chem. Soc. 1942, 64, 503-508. Several methods have been disclosed to prepare copper(II) hydroxide products but they have issues such as low stability, waste water management, pollution, processing cost and process control.

Various processes for the commercial manufacture of copper(II) hydroxide have been described. U.S. Pat. Nos. 1,800,828, 1,867,357, 2,525,242, 2,536,096, 3,635,668 and 4,944,935 describe processes involving ammonia. Ammonia containing waste water materials may not be appropriate for discharge and may be a biological poison, harming the ecosystem and or environment and thus demands effluents processing.

U.S. Pat. Nos. 4,490,337 and 4,808,406 describe processes involving carbonate; the latter process provides a product containing considerable copper carbonate in addition to copper(II) hydroxide.

U.S. Pat. Nos. 2,924,505, 2666688 3,428,731, 4567220 3,628,920, 7,402,29682, Re 24,324, 4,404,169, German Patent Publication DE 19543803A1, PCT Patent Publication WO 02/083566 A2 and European Patent EP 80226 B1 describe processes involving phosphate.

It is to be noted that U.S. Pat. No. 7,402,296B2 states that none of the above noted art pertain to stabilizing copper(II) hydroxide. Therefore, U.S. Pat. No. 7,402,296B2 describes processes for the stabilization of copper(II) hydroxide using water-soluble phosphate after the copper(II) hydroxide has been made separately either as a dry powder, as a slurry in water, or as a high moisture solid. Therefore an additional processing step is required to stabilize the copper(II) hydroxide.

The major disadvantage of the phosphate method is use of excess phosphate. According to U.S. EPA (United States Environmental Protection Agency) Report on the Environment http://www.epa.gov/roe/, phosphorus can result in cultural eutrophication.

Eutrophications affects wildlife and possibly health of humans and as a result limit sustainable social development. Therefore, its release to surface waters in agricultural runoff and wastewaters has led to legislation, such as the European Union Urban Wastewater Directive (Commission of the European Communities; Directive concerning urban wastewater treatment (91/271/EEC) Official Journal, 1991:L135/40) which was designed to remove phosphorus from domestic and industrial wastewater.

A significant advantage of the present invention is the copper(II) hydroxide can be stabilized during the preparation process thus eliminating the need of an additional processing steps for stabilization of the product. Another particular feature of the present invention is the use of gluconate as a stabilizer which cause no threats to the environment. Another major advantage of the process is that it produces finely divided powder particles of copper(II) hydroxide of high stability. At high temperature (85° C. for 1 hour) the copper(II) hydroxide blue color was preserved with no change in the XRD diagram and no trace of the copper(II) oxide. This stability feature is significantly better than what has been described in the related art and well above the recommendation of The Food and Agriculture Organization of the United Nations which has defined an accelerated storage procedure, to assess the stability of plant protection products, Method MT 46, involving heating at 54±2° C. for 14 days (see Manual on Development and Use of FAO Specifications for Plant Protection Products, Fifth Edition, January 1999, sections 3.6.2 and 5.1.5). A particular feature of the use of the gluconate stabilized copper(II) hydroxide process is an excellent temperature stability, better storage and shelf life, ease of the process, precise process control, high surface area and insignificant waste water treatment.

### SUMMARY OF THE INVENTION

The present invention is directed to the methods of producing stable copper(II) hydroxide suitable for use as an agriculture pesticide, fungicidal, bactericidal, anti-pathogen or biocidal and other industrial applications.

The present invention discloses the production of chemically stable and color stable copper(II) hydroxide by use of an alkali or alkaline metal gluconate.

The present invention comprises a process where copper metal preferably −200 mesh is added to an acidic aqueous solution containing acetic acid at pH less than 3.0 and temperature below 30° C. The pH of the acidic solution is raised above 7.0 by adding alkali metal hydroxide solution in the presence of an alkali and or alkaline metal gluconate preferably sodium gluconate to form insoluble copper(II) hydroxide. Alkali and or alkaline metal gluconate can also be introduced after the formation of copper(II) hydroxide to stabilize the product.

The present invention also comprises a process whereby a solution of copper salts, preferably copper(II) sulfate and an alkali or alkaline metal gluconate preferably sodium gluconate solution is reacted with an alkali metal hydroxide such as sodium hydroxide to form insoluble copper(II) hydroxide. Alkali or alkaline metal gluconate can also be introduced after the formation of copper(II) hydroxide to stabilize the product.

All the reactions are carried out in an aqueous medium at temperature below 30° C. It has been found that more stable product is formed at lower reaction temperatures. The copper(II) hydroxide thus formed is filtered, washed and dried.

The present method provides the significant advantage for a stable copper(II) hydroxide and as well as and prevents chemical decomposition to copper(II) oxide retaining its blue color even when subjected to elevated temperatures. Another advantage of the method is that the stabilization of copper(II) hydroxide can be achieved during formation of the copper(II) hydroxide. No post stabilization steps are needed as in the current state of the art. This is particularly useful because the stabilization method utilizing an alkali or alkaline metal gluconate can be applied to copper(II) hydroxide produced by any of the commercial processes and does not require modification of their process conditions.

This invention also relates to stabilized copper(H) hydroxide prepared according to said method, and to a composition comprising stabilized copper(II) hydroxide and at least one of a plant derived agents demonstrated to have antifungal, antibacterial or antiviral activity as a solid or a liquid or as surfactant or as a coating.

### DETAILED DESCRIPTION OF THE INVENTION

In a first embodiment, the process is carried out by adding copper metal powder preferably −200 mesh to an acidic aqueous solution containing acetic acid at pH less than 3.0 maintaining temperature below 30° C., To this acidic solution was added sodium gluconate under continuous stirring. Periodically sodium hydroxide was added to raise the pH between 7.0 and 12. Insoluble blue color-stable copper(H) hydroxide is formed which remains stable at high temperature. After the reaction, the suspension was filtered, washed and dried to obtain the final stable copper(II) hydroxide powder.

As referred to herein, the copper metal include copper powder from −40 mesh to −325 mesh preferably −200 mesh or copper flakes or wire millimeter in size and thickness less than 100 micron preferably less than 50 micron thickness. The preferred range of copper metal is 0.1 to 7.5 weight % of the total weight solution and more preferably 0.5% to 3.5 weight % of the total weight solution.

The acids include carboxylic acids characterized by a carboxyl (—COOH) functional group such as formic acid, acetic acid, oxalic acid and a like and more preferably acetic acid.

The preferred range of the pH of the solution maintained by acetic acid is 1.0 to 4.0 and more preferably 1.5 to 2.5.

The alkali gluconates are preferably those of sodium, potassium and lithium and more preferably sodium gluconate. The alkaline gluconate are preferably those of calcium, magnesium, strontium and barium and more preferably calcium gluconate. The preferred range of sodium gluconate is 0.001% to 5 weight % of the total weight solution and more preferably 0.1% to 2 weight % of the total weight solution.

The alkali hydroxides are preferably those of sodium, potassium and lithium and more preferably sodium hydroxide. The preferred range of sodium hydroxide solution is 1 to 6 M (molar) and more preferably 4 to 5 molar.

It should be noted that the temperature, pH of the liquor solution, copper metal mesh size determine the rate of the reaction and the product characteristics.

In another embodiment of the invention, the process is carried out by dissolving copper salts such as, copper(II) sulfate pentahydrate in water maintaining temperature below 30° C. To this system sodium gluconate was then added under continuous stirring. The pH of the solution is raised above 7.0 periodically with a solution containing alkali metal hydroxide such as sodium hydroxide. The insoluble color-stable copper(II) hydroxide is formed, After the reaction, the suspension was filtered, washed and dried to obtain the final stable copper(II) hydroxide powder.

As referred to herein, the copper salts include copper(II) sulfate, copper(II) sulfate pentahydrate, copper chloride, copper nitrate and the like. The preferred molar concentration of copper salts such as copper(II) sulfate is 0.001 to 2 molar preferably 1 to 1.5 molar.

The preferred alkali or alkaline gluconate and alkali hydroxide and their range are similar as described previously in this section. It should be noted that the alkali or alkaline metal gluconate can be combined in any order such as before treating with sodium hydroxide or after the formation of copper(II) hydroxide suspensions.

It should be noted that the pH control is very critical and should not be allowed to exceed 12.0, and more preferably should be maintained in the pH range 8.5 to 11.5.

The temperature of the reaction medium plays an important role in defining the final product and should be kept below 30° C. throughout the process. The preferred range for temperature is 0° C. to 30° C. and more preferably 20° C. to 25° C.

In another embodiment of the invention, for preparation of multi-component pesticides, fungicidal, bactericidal, anti-pathogen or biocidal and other industrial applications compositions the recovered dried copper(II) hydroxide is typically mixed with at least one of a plant derived agents demonstrated to have antifungal, antibacterial or antiviral activity as a solid or a liquid or as a surfactant or as a coating. Plant extract include such as curcumin, piperine, neem extract, neem oil, clove oil and the like.

Without further elaboration, it is believed that one skilled in the art using the preceding description can utilize the present invention to its fullest extent. The invention can be illustrated more fully with respect to the following examples, which are not intended to limit the scope of the invention.

### EXEMPLARY EMBODIMENTS

### Example 1

A 1 liter solution of pH 2.3 was prepared by dissolving appropriate amount of acetic acid. Then 15 grams of copper powder of −200 mesh were added to the solution and were treated at room temperature with continuous stirring. At this stage, 1 gram of sodium gluconate dissolved in 5 ml water was added with stirring. A sodium hydroxide solution is prepared by adding 40 grams of sodium hydroxide to water and diluting to 0.25 liters to give a four molar solution. The sodium hydroxide solution is allowed to cool to ambient temperature before proceeding with the reaction. Sodium hydroxide is then added to the reactor to form copper(II) hydroxide from the acidic aqueous solution. After the reaction, the suspension was filtered, washed and dried to obtain the final copper hydroxide powder.

### Example 2

A 1 liter solution of pH 2.3 was prepared by dissolving an appropriate amount of acetic acid. Then 15 grams of copper powder of −200 mesh were added to the solution and were treated at room temperature with continuous stirring. A sodium hydroxide solution is prepared by adding 40 grams of sodium hydroxide to water and diluting to 0.25 liters to give a four molar solution. The sodium hydroxide solution is allowed to cool to ambient temperature before proceeding with the reaction. Sodium hydroxide is then added to the reactor to form copper hydroxide from the copper acetate complex solution. To copper(II) hydroxide suspension. 1 gram of sodium gluconate dissolved in 5 ml water was added with stirring to stabilize the product. After the reaction, the suspension was filtered, washed and dried to obtain the final copper(II) hydroxide powder.

### Example 3

To 1 liter of water was added 250 grams of copper(II) sulfate pentahydrate, which was stirred until all of the solids dissolved. To this solution was added a solution of sodium gluconate prepared by dissolving 4.2 gram in 50 ml of water under continuous stirring. To this system was added cooled 5 molar sodium hydroxide solution to bring the final pH of this system to 10.5. After the reaction, the suspension was filtered, washed and dried to obtain the final copper(II) hydroxide powder.

### Example 4

To 1 liter of water was added 250 grams of copper(11) sulfate pentahydrate, which was stirred until all of the solids dissolved. To this system was added cooled 5 molar sodium hydroxide solution to bring the final pH of this system to 10.5. To this system was added a solution of sodium gluconate prepared by dissolving 4.2 gram in 50 ml of water under continuous stirring. After the reaction, the suspension was filtered, washed and dried to obtain the final copper(II) hydroxide powder.

### ANALYTICAL EXAMPLES

To assess the stability of copper(II) hydroxide, prepared by the methods of the present invention, at elevated temperatures following testing procedures are now described. In these procedures decomposition of copper(II) hydroxide is measured colorimetrically, as with decomposition copper(II) hydroxide blue color is lost.

### Analytical Example 1 Oven Test Method

The “Oven Test Method” involves heating dry copper(II) hydroxide powder at 54° C., as does FAO Method MT 46 cited in the Background of the Invention. In this test, a quantity of copper(II) hydroxide powder is placed in a glass container and sealed with a lid. The color of the powder in the glass container is measured using a calorimeter and the “b” value is recorded. According to the CIELAB color model, the “b” values of blue materials are negative numbers; the greater the blue intensity, the larger-the negative number. The sealed glass container is placed in an oven maintained at a constant temperature of 54° C. The container is removed periodically for additional measurements, taking care to mix the contents of the container prior to measuring the color. The “b” value for this test is −10.

### Analytical Example 2 Hot Water Test Method

In this test, a typical ratio is 5 g of copper(II) hydroxide powder is added to 100 g of water and is heated for 30 minutes with continuous stirring to at least 80° C. The suspension is cooled and the color of the suspension is then measured with a calorimeter such as the one described for Analytical Example 1. The “b” value for this test is −15.

The invention has been described with respect to preferred embodiments. However, as those skilled in the art will recognize, modifications and variations in the specific details which have been described and illustrated may be resorted to without departing from the spirit and scope of the invention.

What is claimed is:

1. A method for preparing color-stable Copper(II) hydroxide comprising the steps of:
a) maintaining a temperature below 30° C. throughout the steps to follow;
b) providing an aqueous acidic solution having a carboxyl (—COOH) functional group acid at a pH less than 3.0, while maintaining a temperature below 30° C.;
c) adding copper metal to the aqueous solution;
d) adding to the acidic aqueous solution an alkali or alkaline gluconate under continuous stirring; and
e) adding an alkali hydroxide to the solution to raise the pH to between 7.0 and 12 to form insoluble blue copper(II) hydroxide which remains stable at high temperature.

2. The method as claimed in claim 1 wherein the copper metal is in the form of copper powder.

3. The method as claimed in claim 2. wherein the copper powder is of a size of −200 mesh or less.

4. The method as claimed in claim 1 wherein the carboxyl (—COOH) functional group acid is selected from the group of: formic acid, acetic acid and oxalic acid. :5, The method as claimed in claim 1 wherein the alkali gluconates is selected from the group of sodium, potassium and lithium.

6. The method as claimed in claim 1 wherein the alkaline gluconate is selected from the group of calcium, magnesium, strontium and barium.

7. The method as claimed in claim 1 wherein the alkali hydroxide is selected from the group of sodium, potassium and lithium.

8. The method as claimed in claim 1 further comprising the step of adding an agent having antifungal, antibacterial or antiviral activity.

9. A method for preparing stable Copper(II) hydroxide comprising the steps of:
a) maintaining a temperature below 30° C. throughout the steps to follow;
b) dissolving copper salts in water while maintaining a temperature below 30° C.
c) adding to the aqueous solution an alkali or alkaline gluconate under continuous stirring; and
d) adding an alkali metal hydroxide to the solution to raise the pH to between 7.0 and 12 to form insoluble copper(II) hydroxide which remains stable at high temperature.

10. The method as claimed in claim 9 wherein the copper salts include at least one of: copper(II) sulfate, copper(II) sulfate pentahydrate, copper chloride, and copper nitrate.

11. The method as claimed in claim 9 wherein the alkali gluconate is selected from the group of sodium, potassium and lithium.

12. The method as claimed in claim 9 wherein the alkaline gluconate is selected from the group of calcium, magnesium, strontium and barium.

13. The method as claimed in claim 9 wherein the alkali hydroxide is selected from the group of sodium, potassium and lithium.

14. The method as claimed in claim 9 further comprising the step of adding an agent having antifungal, antibacterial or antiviral activity.

15. A method of stabilizing copper(II) hydroxide by adding an alkali or alkaline metal gluconate to the copper(II) hydroxide after formation.
